(19) United States
(12) Patent Application Publication
(10) Pub. No.: US 2015/0203334 A1
(43) Pub. Date: Jul. 23, 2015

(54) Crane Trolley and Hoist Position Homing and Velocity Synchronization

(71) Applicant: Mi-Jack Products, Inc., Hazel Crest, IL (US)

(72) Inventors: Matthew M. Moran, Woodridge, IL (US); Steven Pfeifenroth, Chicago, IL (US)

(73) Assignee: Mi-Jack Products, Inc., Hazel Crest, IL (US)

(21) Appl. No.: 14/158,538

(22) Filed: Jan. 17, 2014

(51) Int. Cl. B66C 13/22; B66C 19/00

(52) U.S. Cl. CPC B66C 13/22; B66C 19/005

(57) ABSTRACT

A method of transferring a load is disclosed. The method includes the steps of enabling synchronization of first and second hoists and first and second trolleys and choosing a hoist function or a trolley function. The first and second hoists are a first mover and second mover, if the hoist function is selected. The first and second trolleys are the first and second movers, if the trolley function is selected. The method includes the steps of commanding one of the first mover and second mover to be the master and the other to be the slave and actuating a master control associated with the master. The method further includes the step of outputting signals to the first and second actuators such that the master and the slave are moved in a direction indicated by the master control.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to crane control systems in general, and specifically to a synchronization system for level-beam, cantilever and overhead gantry cranes having a hoist suspended from a trolley for lifting a load and a trolley for transporting the load laterally along one or more beams associated with the crane.

2. Description of the Background of the Invention

Level-beam, cantilever cranes and overhead gantry cranes such as Rail-Mounted Gantry cranes (“RMG”) and Rubber Tire Gantry cranes (“RTG”), are used to move loads of varying size and weight from one location to another. Often cranes such as the RTG crane shown in FIG. 1 include one or more trolleys and hoists, which are used to move large, heavy loads. Due to a variety of factors such as uneven load weight, wind, crane motion, and the acceleration and deceleration of the trolley, loads tend to sway or swing during movement. Load sway is problematic because loading and unloading operations cannot take place if the load is swaying at the end of movement. If a load is swaying at the end of movement, an operator must either wait for the load to stop swaying or maneuver the trolley and/or hoists in a manner that negates the swaying movement. This waiting and/or maneuvering can take up to one third or more of the total transfer time.

Several anti-sway systems have been developed to counteract the sway of loads during movement. One such system is disclosed in Overton, U.S. Pat. No. 5,526,946. The anti-system system disclosed in Overton uses a double-pulse, anti-sway algorithm that is based on a single pendulum length to negate the affects of sway caused by acceleration of the trolley, movement of the hoists, and external factors.

However, not all sway movement is in the form of a single pendulum as shown in FIGS. 2 and 2A. Often time uneven hoists or misaligned trolleys cause sway that has a circular motion, which is difficult to control, rather than a single pendulum-type motion. For example, FIGS. 3 and 3A show an example of one type of a circular sway caused by misaligned front and rear trolleys. In this example, all the hoists are even, i.e., at the same height, but the front and rear trolleys are misaligned, i.e., the front and rear trolleys are not square with the beams of the crane. Likewise, FIGS. 4 and 4A illustrate an example of a circular sway that is caused by uneven hoists. Here, the trolleys are properly aligned but the hoists are not even.

To address the problem of uneven hoists and misaligned trolleys, an operator must skillfully synchronize all the hoists and trolleys using multiple independent controls, which is time consuming and imperfect. Other methods for control require mechanical bridges that replace or are connected to the trolleys and hoists in order to mechanically synchronize them. Such devices are very expensive, and therefore not practical to implement.

Given the limitations of the prior art, there exists a need for a single control for all trolleys and a single control for all hoists so that synchronization of the trolleys and hoists can be obtained quickly and efficiently. By synchronizing the trolleys and hoists, uncontrollable swing of the lifted load will be greatly reduced, thereby improving productivity, increasing safety, and reducing operator fatigue.

It would also be an improvement in the art to enable synchronization of the trolleys and hoists so that anti-sway technology can be used to eliminate further load sway during lateral movement of the load.

### SUMMARY

Disclosed is a method of transferring a load using a transport device. The transport device has a first hoist and a second hoist and a first trolley and a second trolley. The first hoist is connected to the first trolley and the second hoist is connected to the second trolley. The method includes the step of enabling synchronization of the first and second hoists and the first and second trolleys. Synchronization includes the steps of leveling the first and second hoists and squaring the first and second trolleys. The method also includes the step of choosing one of a hoist function and a trolley function. If the hoist function is selected, the first and second hoists are a first mover and second mover, respectively; and if the trolley function is selected the first and second trolleys are the first and second movers, respectively. The method further includes the step of commanding one of the first mover and the second mover to be the master and the other mover to be the slave. The master is connected to a first actuator and the slave is connected to a second actuator. The method includes the steps of actuating a master control associated with the master and outputting a signal to the first and second actuators such that the first actuator moves the master and the second actuator moves the slave in a direction indicated by the master control.

Also disclosed is a system for synchronization. The system includes a transport device having a first hoist and a second hoist and a first trolley and a second trolley, wherein the first hoist is connected to the first trolley and the second hoist is connected to the second trolley. The system also includes a first hoist actuator connected to the first hoist, a second hoist actuator connected to the second hoist, a first trolley actuator connected to the first trolley, and a second trolley actuator connected to the second trolley. The system further includes a program logic controller that includes a synchronization module for synchronizing movement of the first and second hoists and the first and second trolleys. The system also includes a master control connected to one of the first hoist and the first trolley. If operational control of the first and second hoists is selected, then the first hoist is a master and the first hoist actuator is a master actuator and the second hoist is a slave and the second hoist actuator is a slave actuator. If operational control of the first and second trolleys is selected, then the first trolley is the master and the first trolley actuator is the master actuator and the second trolley is the slave and the second trolley actuator is the slave actuator. The master control is used to send directions to move the master via the master actuator and move the slave via the slave actuator such that the slave moves at substantially the same rate as the master.

Other aspects and advantages of the disclosed method and system will become apparent upon consideration of the following detailed description.

### BRIEF DESCRIPTION OF THE DRAWINGS

FIG. 1 is a trimetric view of one embodiment of a crane;

FIG. 1A is a trimetric view of another embodiment of the crane of FIG. 1;

FIG. 2 is a front elevational view of another embodiment of the crane of FIG. 1 with a load attached to multiple hoists suspended from trolleys disposed on the top beams of the crane, illustrating the single-pendulum swinging direction of the load when the hoists are level and the trolleys are square with the top beams;

FIG. 2A is a diagrammatic plan view of the crane of FIG. 2, illustrating the swinging direction of the load;

FIG. 3 is a front elevational view of another embodiment of the crane of FIG. 1 with a load attached to multiple hoists suspended from trolleys disposed on the top beams of the crane, illustrating the circular swinging direction of the load when the trolleys are not square with respective to the top beams of the crane;

FIG. 3A is a diagrammatic plan view of the crane of FIG. 3, illustrating the swinging direction of the load;

FIG. 4 is a front elevational view of another embodiment of the crane of FIG. 1 with a load attached to multiple hoists suspended from trolleys disposed on the top beams of the crane, illustrating the circular swinging direction of the load when the hoists are not level;

FIG. 4A is a diagrammatic plan view of the crane of FIG. 4, illustrating the swinging direction of the load;

FIG. 5 is a partial perspective view of the interior of an operator control station associated with the crane of FIG. 1;

FIG. 5A is a partial perspective view of a left control console of the operator control station of FIG. 5;

FIG. 5B is a partial perspective view of a right control console of the operator control station of FIG. 5;

FIGS. 6A and 6B are flow charts illustrating one embodiment of a method of transporting a load;

FIG. 7A is a schematic view illustrating one embodiment of a system of transporting a load;

FIG. 7B is a schematic view illustrating another embodiment of a system of transporting a load; and

FIG. 8 is a trimetric view of another embodiment of a crane having three trolleys disposed on each top beam.

### DETAILED DESCRIPTION OF THE PREFERRED EMBODIMENTS

As used herein, the terms first, second, third and the like are used to distinguish between similar elements and not necessarily for describing a specific sequential or chronological order. The terms are interchangeable under appropriate circumstances and the embodiments of the invention can operate in other sequences than described or illustrated herein.

In addition, the terms top, bottom, front, rear, left, right and the like as used herein are used for descriptive purposes and not necessarily for describing specific positions. The terms so used are interchangeable under appropriate circumstances and the embodiments of the invention described herein can operate in other orientations than describe or illustrated herein.

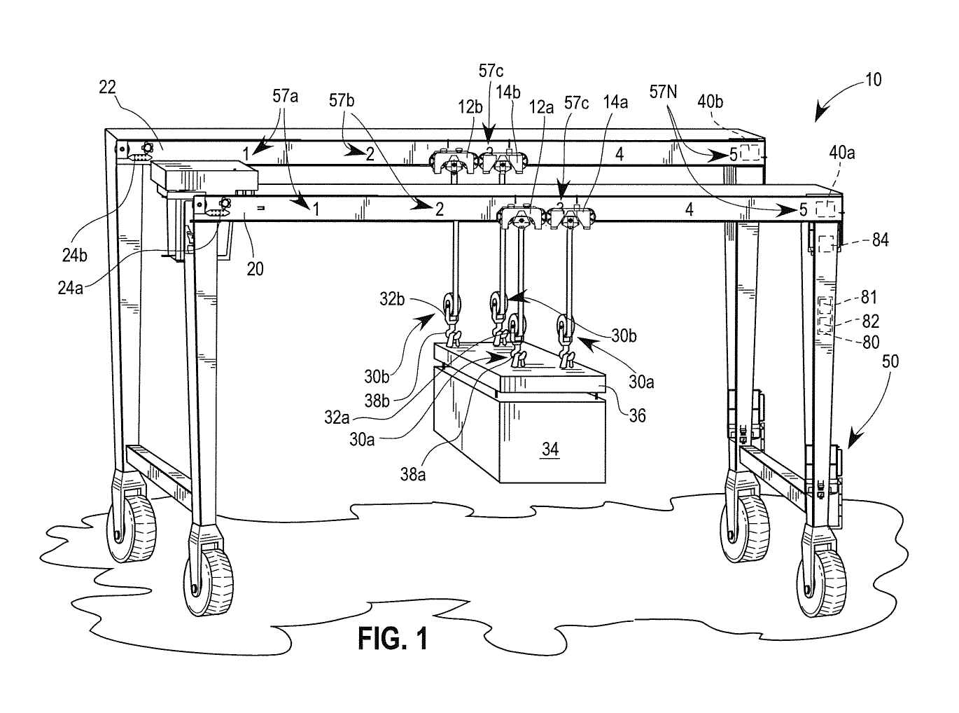

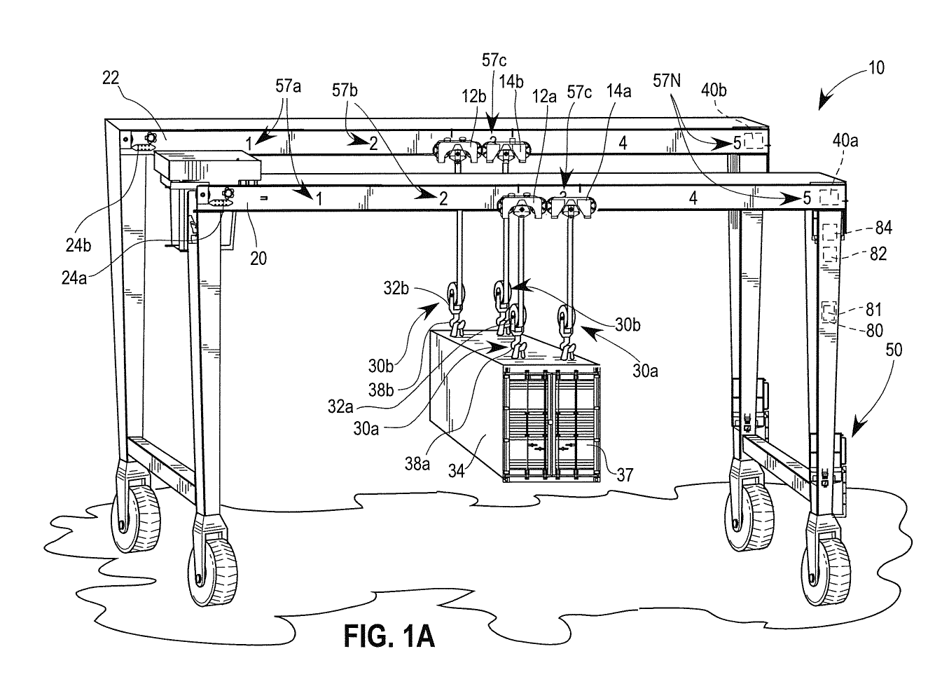

FIG. 1 shows one embodiment of a level-beam gantry crane 10. The crane 10 of FIG. 1 includes a front top beam 20 and a rear top beam 22. A first front trolley 12a and a second front trolley 14a are moveably mounted on the front top beam 20, and a first rear trolley 12b and a second rear trolley 14b are moveably mounted on the rear top beam 22. Although in FIG. 1 only two front trolleys 12a, 14a are shown on the front top beam 20 of the crane 10 and two rear trolleys 12b, 14b are shown on the rear top beam 22, any number of trolleys (e.g., three, four, five, etc.) may be disposed on the top beams 20, 22 of crane 10. The first and second front trolleys 12a and 14a, respectively, are connected to a front trolley actuator 24a. The front trolley actuator 24a may be mounted on the front top beam 20 and controls the lateral movement of front trolleys 12a, 14a along the front top beam 20. Likewise, the first and second rear trolleys 12b and 14b, respectively, are connected to a rear trolley actuator 24b. The rear trolley actuator 24b may be mounted on the rear top beam 22 and controls the lateral movement of rear trolleys 12b, 14b along the rear top beam 22. Although a single trolley actuator (i.e., 24a and 24b) is shown on each of the front and rear top beams 20, 22 in FIG. 1, individual actuators for each trolley may also be used within the scope and intent of this invention. In the illustrative example shown in FIG. 1, the trolley actuators 24a, 24b are hydraulic motors. Other actuators such as electric motors, hydraulic cylinders, electric linear actuators, or other suitable means may be used within the scope and intent of this invention for producing trolley motion along the top beams 20, 22 of the crane 10.

Attached to and vertically suspended from the first and second front trolleys 12a and 14a, respectively, are front hoist members 30a. The front hoist members 30a each include a hoist sheave block 32a and a hook block 38a, which is connected to the sheave block 32a. Similarly, attached to and vertically suspended from the first and second rear trolleys 12b and 14b, respectively, are rear hoist members 30b. The rear hoist members 30b each include a hoist sheave block 32b and a hook block 38b, which is attached to the sheave block 32b. As shown in FIG. 1, the hook blocks 38a, 38b engage a spreader 36, which is used to raise and lower a load 34 such as a shipping container 37 (see FIG. 1A), precast concrete, steel, and/or other large objects. Alternatively, the hook blocks 38a, 38b may be attached directly to the load 34, for example the container 37 of FIG. 1A, when suitable lift points are employed on the load 34. In the illustrative embodiment of FIG. 1, the front hoist members 30a are connected to and suspended from a front hoist actuator 40a and the rear hoist members 30b are connected to and suspended from a rear hoist actuator 40b. In this embodiment, the front hoist actuator 40a lifts and lowers the front hoist members 30a, and the rear hoist actuator 40b lifts and lowers the rear hoist members 30b. Although two hoist actuators 40a, 40b are shown in FIG. 1, multiple hoist actuators (e.g., three, four, five, etc.), each controlling individual hoist members or multiple hoist members may be used. The front and rear hoist actuators 40a and 40b, respectively, may be drum and wire rope devices as known in the art, and may be driven by hydraulic motors, electric motors, or other suitable means within the scope and intent of the invention.

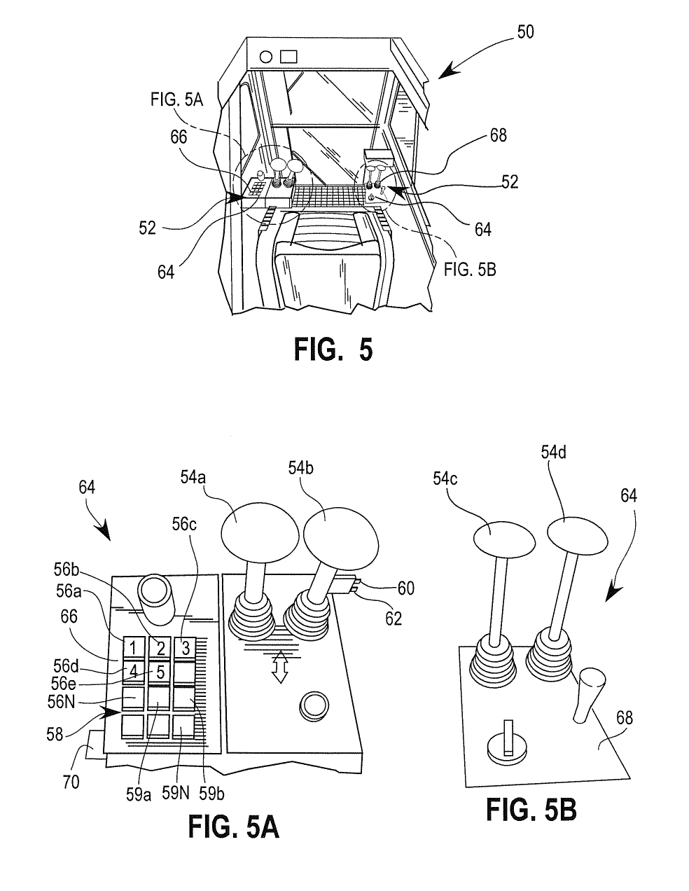

The crane 10 may have a control station 50 disposed on or adjacent to the crane 10. Turning to FIGS. 5-5B, the control station 50 may include multiple controls mechanisms 52. The control mechanisms 52 may include controls 54 for the hoist members 30a, 30b and the trolleys 12a, 12b, 14a, 14b such as joysticks 54a, 54b, 54c, and 54d (FIGS. 5A and 5B), a key pad 58 (FIG. 5A), a synchronization button 60 (FIG. 5A), and a suspend button 62 (FIG. 5A). The controls 54 may be disposed on one control console 64 or they may be disposed on multiple control consoles 64. For example, the controls 54a, 54b may be disposed on a left console 66 and controls 54c, 54d may be disposed on a right console 68 as shown in FIGS. 5A and 5B. Alternatively, the control consoles 64 may be presented virtually on a computer display (not shown). An indicator mechanism 70 may also be included on the left console 66 (see FIG. 5A) or the right console 68, or anywhere in the control station 50 where the operator can see, hear, or feel the signal generated by the indicator mechanism 70.

Each control 54a, 54b, 54c, 54d may be associated with one or more of the front trolleys 12a, 14a, the rear trolleys 12b, 14b, the front hoist members 30a, and the rear hoist members 30b. In the illustrative example, there are four controls, a front trolley control 54a, a rear trolley control 54b, a front hoist control 54c, and a rear hoist control 54d. In the illustrative example, the front trolley control 54a is electrically connected to the first and second front trolleys 12a and 14a, respectively, via the front trolley actuator 24a and is used to direct lateral movement of the front trolleys 12a, 14a. Likewise, the rear trolley control 54b is electronically connected to the first and second rear trolleys 12b and 14b, respectively, via rear trolley actuator 24b and is used to direct lateral movement of the rear trolleys 12b, 14b. The front hoist control 54c is electronically connected to the front hoist members 30a via the front hoist actuator 40a and directs the front hoist members 30a to move substantially in a vertical, up or down direction. The rear hoist control 54d is electronically connected to the rear hoist members 30b via the rear hoist actuator 40b and directs the rear hoist members 30b to move substantially in a vertical, up or down direction.

The key pad 58 may include any number of automatic trolley controls 56a, 56b, . . . , 56N that have one or more functions assigned to each control. The controls may be associated, for example, with any number or combinations of pre-set locations 57 located incrementally along the front top beam 20 and the rear top beam 22 of the crane 10, as shown in FIG. 1. In the illustrative example, the key pad 58 has five buttons 56a, 56b, 56c, 56d, and 56e, which are labeled “1”, “2”, “3”, “4”, and “5”, respectively. Each of the five numbered buttons, in the illustrative example, is associated with a single pre-set location 57 on the top beams 20 and 22; therefore, there are five pre-set locations 57 disposed on both the front top beam 20 and the rear top beam 22 as shown in FIG. 1. Each of the pre-set locations 57 on the front top beam 20 corresponds to a pre-set location 57 on the rear top beam 22. In the illustrative example, the first pre-set location 57a on front top beam 20, which is indicated by the number “1”, is located at the same point on the beam as the first pre-set location 57a of the rear top beam 22, which is also indicated by the number “1”. The second pre-set location 57b on the front top beam 20, which is indicated by the number “2”, is located at the same point on the beam as the second pre-set location 57b of the rear top beam 22, which is also indicated by the number “2”, and so on. To move the trolleys to the first pre-set location 57a on the top beams 20, 22, an operator would activate, for example, the button labeled “1”. To move the trolleys to the second pre-set location 57b on the top beams 20, 22, then the operator would activate the button labeled “2.” To move the trolleys to the third pre-set location 57c on the top beams 20, 22, the operator would activate the button labeled “3” and so on.

The key pad 58 may also contain one or more automatic hoist controls 59a, 59b, . . . , 59N for moving the hoist members 30a and 30b to one or more pre-set hoist positions. For example, the pre-set hoist position may be a position that is located proximate the front trolleys 12a, 14a or rear trolleys 12b, 14b and associated with a button 59a. In the illustrative example, when the button 59a is actuated, the hoist members 30a, 30b move the load 34 toward the top beams 20, 22 and then stop moving when the load 34 reaches the top beams 20, 22. Alternately, the pre-set hoist position may be a position distal to the front or rear trolleys and associated with a button 59b. In the illustrative example, when the button 57b is activated, the hoist members 30a, 30b move the load downward, away from the top beams 20, 22 to a position located at a set distance from the top beams 20, 22. The functions of the automatic trolley and hoist controls 56 and 59, respectively, located on the key pad 58 may be used individually or together and may be used in a manual or synchronized mode (see discussion below).

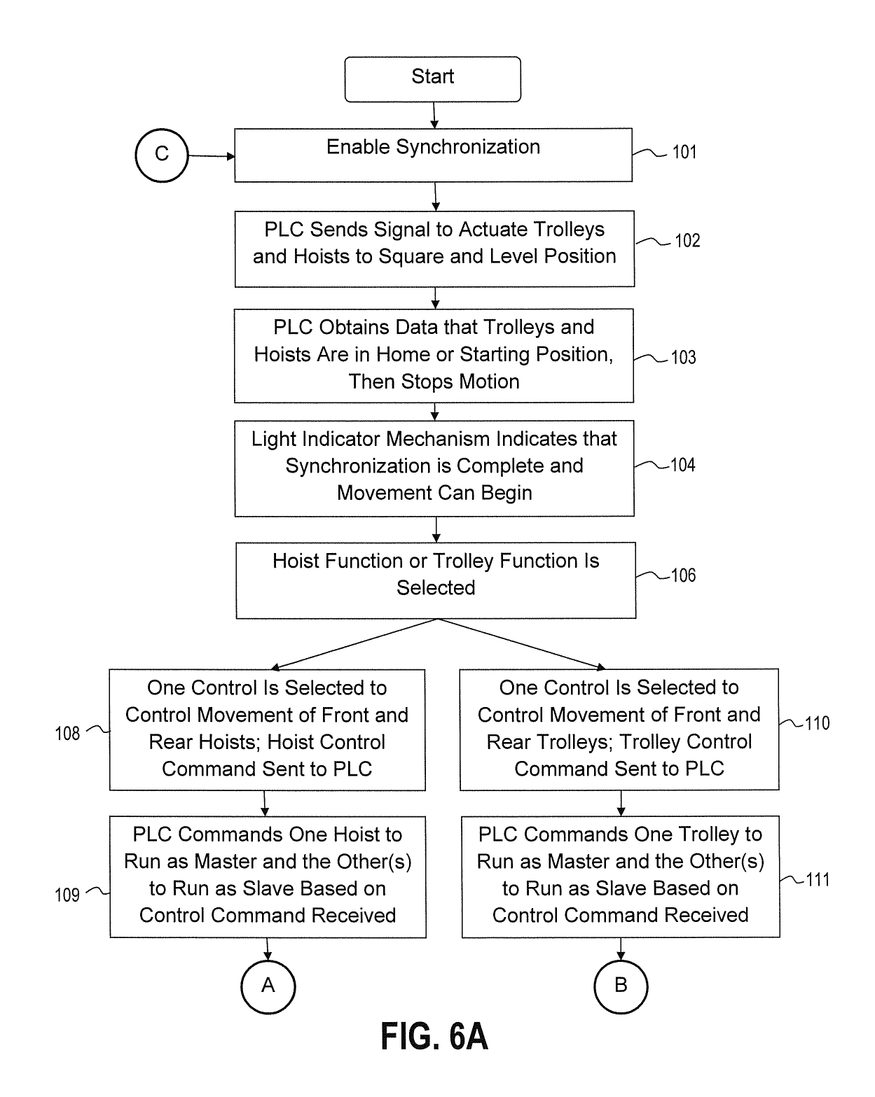

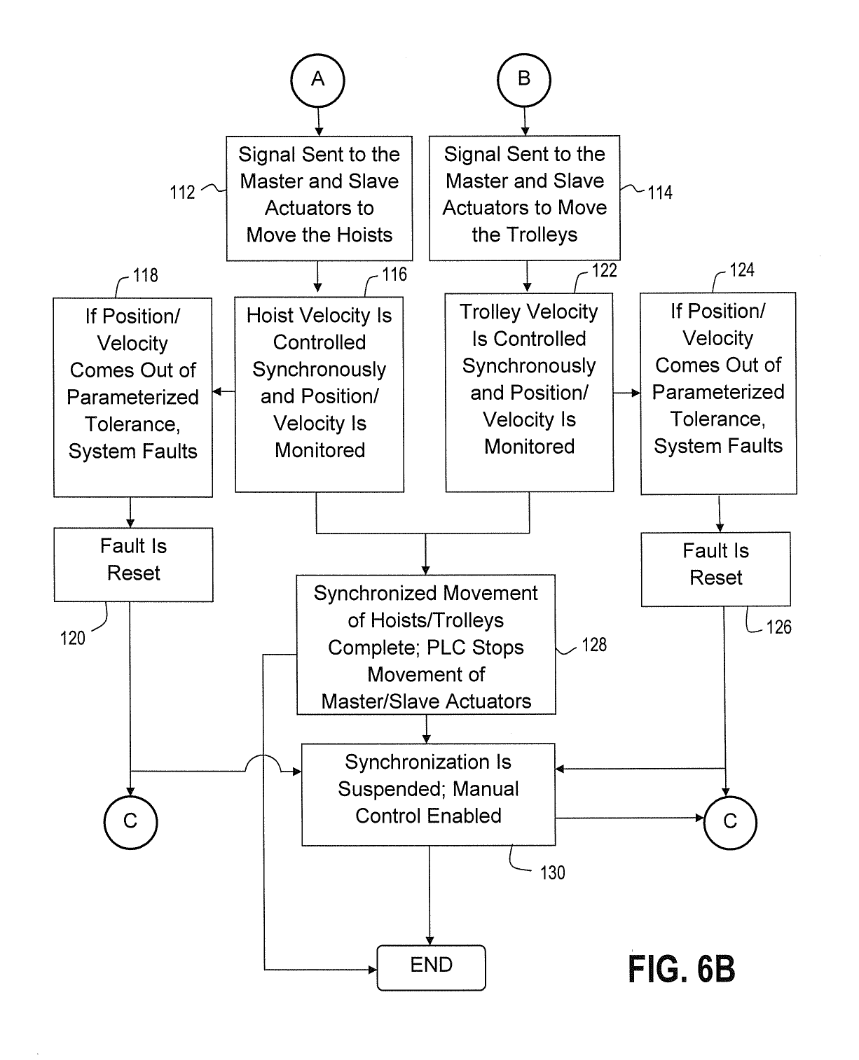

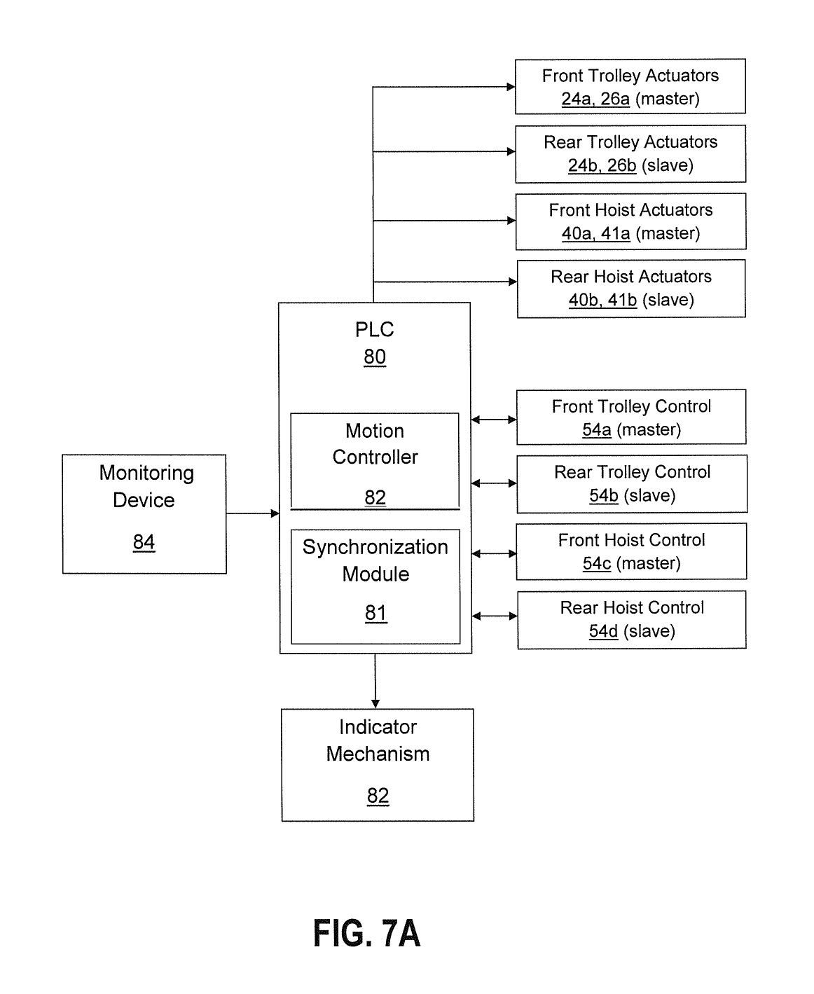

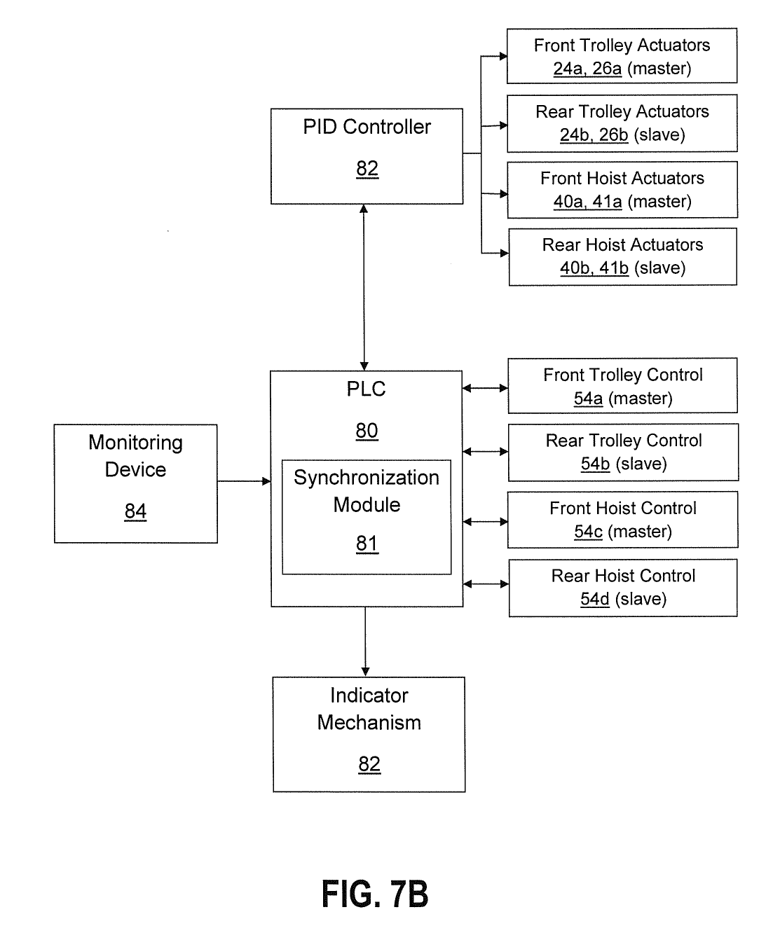

Turning to FIGS. 6A and 6B and FIGS. 7A and 7B, a method 100 and system 200 of transferring the load 34 are shown. At a step 101, a synchronization module 81 of a program logic controller (“PLC”) 80 is enabled. Because PLCs are well-known in the art, further detail regarding such devices is not provided herein. The synchronization module 81 is activated by actuating the synchronization button 60. Although the synchronization button 60 is shown as a physical button disposed on the rear trolley control 54b, the synchronization button 60 may be disposed on any one of controls 54a, 54b, 54c, and 54d, the key pad 58, or any other location that is convenient for an operator. The synchronization button 60 may also be a virtual button that is displayed on a virtual control console (not shown).

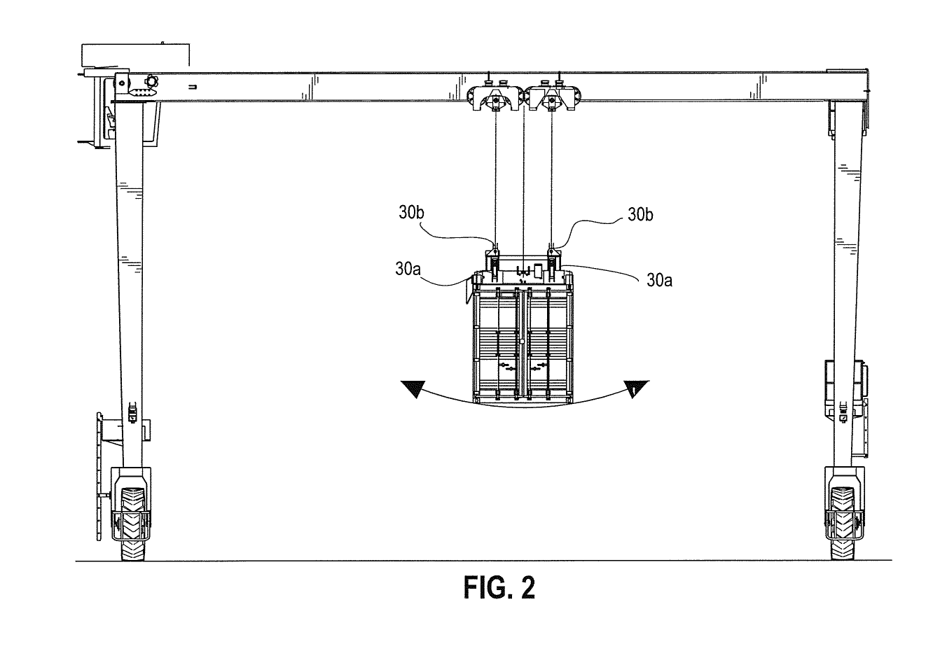

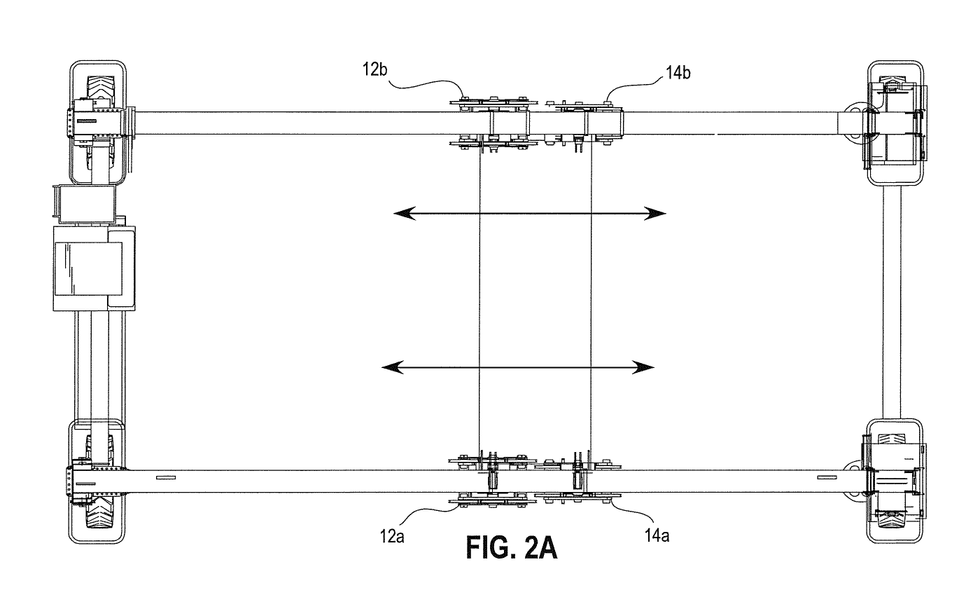

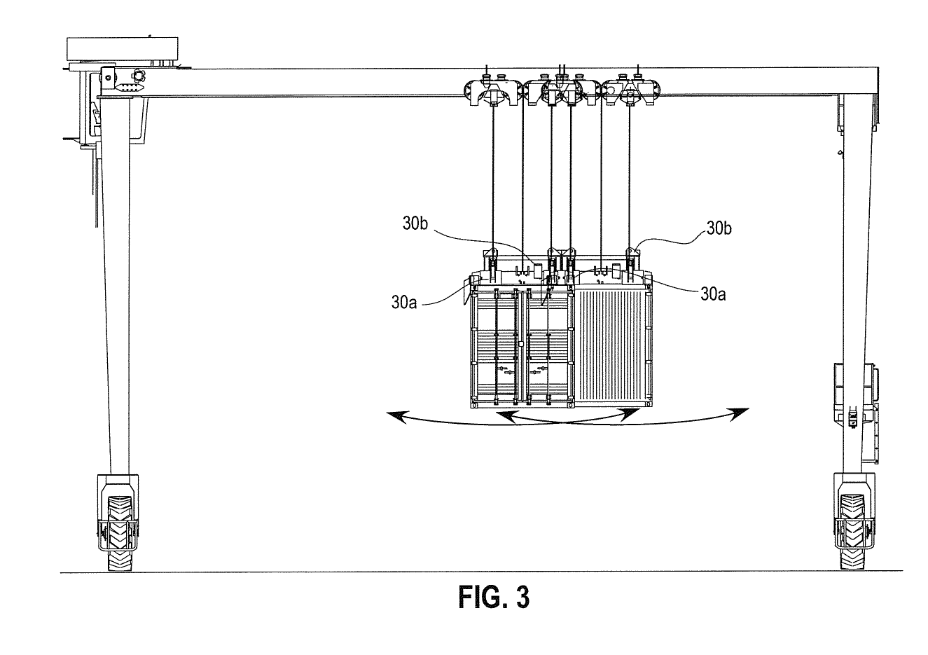

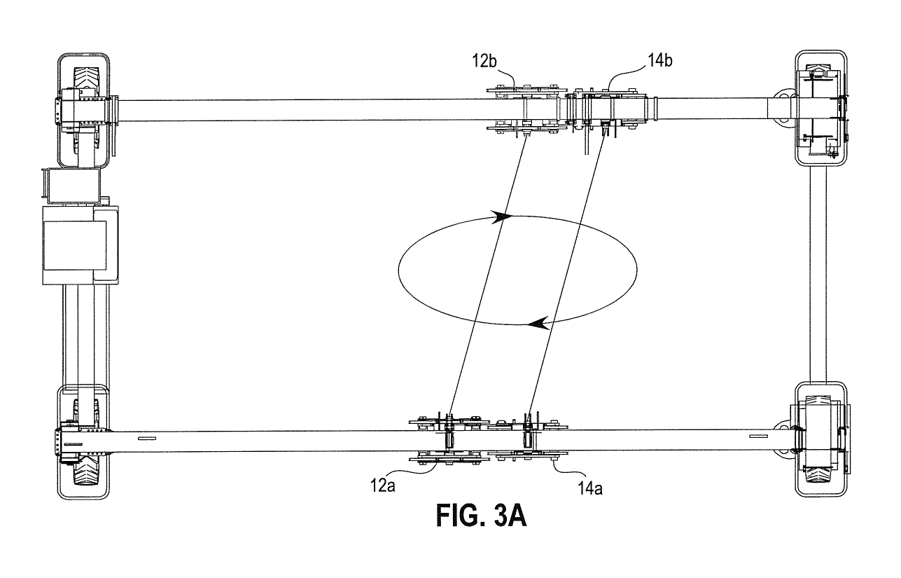

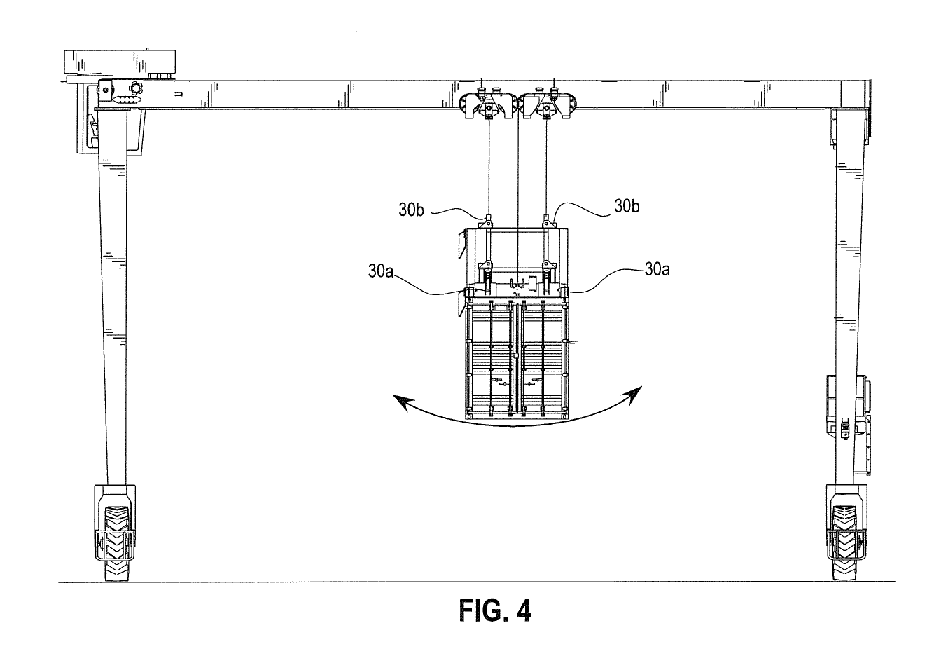

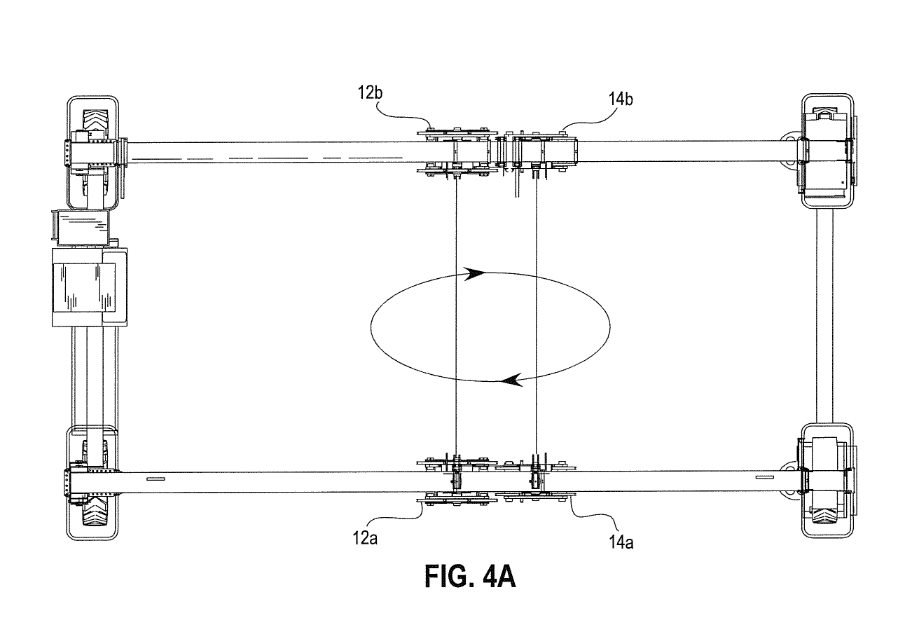

Once synchronization is enabled, at a step 102, the synchronization module 81 of the PLC 80 squares the front and rear trolleys and levels the front and rear hoist members. To square the trolleys, the PLC 80, in the illustrative example, sends a signal to the front trolley actuator 24a and the rear trolley actuator 24b to move the front trolleys 12a, 14a along front top beam 20 and the rear trolleys 12b, 14b along the rear top beam 22 so that front trolleys 12a, 14a are disposed at the same position on the front top beam 20 as rear trolleys 12b, 14b are disposed on the rear top beam 22. In the square position, the spreader 36 is perpendicular to the front and rear top beams 20 and 22, respectively (see FIG. 2A). To level the hoist members, the PLC 80 sends a signal to the front and rear hoist actuators 40a and 40b to move the front and rear hoist members 30a and 30b, respectively, to a position in which the hook blocks 38a of each of the front hoist members 30a on the front top beam 20 are level with the hook blocks 38b of each of the front hoist members 30b on the rear top beam 22, i.e., located at the same vertical distance from the front trolleys 12a, 14a and the rear trolleys 12b, 14b (see FIG. 2).

At a step 103, the PLC 80 obtains data regarding the position of the front and rear hoist members 30a and 30b, the front trolleys 12a, 14a, and the rear trolleys 12b, 14b from a monitoring device 84. Based on the data received from the monitoring device 84, the PLC 80 determines when the front and rear hoist members 30a and 30b, respectively, have been leveled, and the front trolleys 12a, 14a and the rear trolleys 12b, 14b have been squared. When that occurs, the hoists and trolleys are in their home or starting position. The PLC 80 then stops movement of the hoists 30a, 30b and trolleys 12a, 12b, 14a, 14b.

The monitoring device 84 may be any device that produces a value that can be used to calculate a position, velocity, and/or acceleration. For example, the monitoring device 84 may be an optical device such as a laser, an inertial measurement device (discussed below), a counting device such as an encoder, tachometer, or resolver, a pulsing device such as a Hall effect sensor or an ultrasonic device, or any other suitable device known in the art. A single monitoring device 84 may be used to monitor all the hoists and trolleys or multiple monitoring devices 84 may be used.

At a step 104, the indicator mechanism 70 is actuated by the PLC 80. The indicator mechanism 70 indicates to an operator that homing is complete and synchronized movement of the load 34 can begin. The indicator mechanism 70 may be a visual, audible, or physical signal. For example, the visual signal may be a flashing light, the audible signal may be a beeping alarm, and the physical signal may be a mechanism that causes vibration of the operator's seat.

At a step 106, movement of either the hoist members 30a, 30b (“the hoist function”) or the trolleys 12a, 12b, 14a, 14b (“the trolley function”) is selected by an operator. The operator may be a person or a virtual operator such as a computer program. The operator chooses the hoist function by selecting one of the front and rear hoist controls 54c and 54d, respectively, and chooses the trolley function by selecting one of the front and rear trolley controls 54a and 54b, respectively.

If the hoist function is selected, then at a step 108 a signal is sent from either the front hoist control 54c or the rear hoist control 54d to the PLC 80 depending on which control is used by the operator to select the hoist function. In the illustrative example, the front hoist control 54c is used to select the hoist function.

At a step 109, the PLC 80 commands the selected hoist control to be a master control 90 and the associated hoist actuator to be a master actuator 92. The hoist actuator associated with the unselected control then becomes a slave actuator 94. If there are more than two hoist actuators, then the additional hoist actuators also become slave actuators if the hoist control associated with the additional actuators is not selected to be the master control by the operator. In the illustrative example, the front hoist control 54c is selected and commanded by the PLC 80 to be the master control 90 and the front hoist actuator 40a is commanded to be the master actuator 92. The rear hoist control 54d is then disabled by the PLC 80 and the rear hoist actuator 40b is commanded to be the slave actuator 94. The slave actuator 94 is directed by the master control 90 to move in the same direction and at the same speed as the master actuator 92. Alternatively, the PLC 80 may enable the rear hoist control 54d to be the master control 90, the rear hoist actuator 40b to be the master actuator 92, and the front hoist actuator 40a to be the slave actuator 94.

If the hoist function is selected, then one of the trolley controls 54a or 54b is automatically commanded by the PLC 80 to be the master trolley control and the other control to be the slave. The trolley actuator corresponding to the master control will become the master actuator and the trolley actuator corresponding to the slave control will become the slave actuator. Therefore, the trolleys may be moved even if the hoist function has been selected. Likewise if the trolley function is selected as discussed below, one of the hoist controls 54c and 54d is automatically commanded by the PLC 80 to be the master hoist control and the other to be the slave. The hoist actuator corresponding to the master control will become the master actuator and the hoist actuator corresponding to the slave control will become the slave actuator. Thus, movement of the hoists may occur even if the trolley function has been selected.

If the trolley function is selected, then at a step 110 a signal is sent from either the front trolley control 54a or the rear trolley control 54b to the PLC 80 depending on which control is used by the operator to select the trolley function. In the illustrative example, the front trolley control 54a is used to select the trolley function.

At a step 111, the PLC 80 commands the selected trolley control to be the master control 90 and the associated trolley actuator to be the master actuator 92. The trolley actuator associated with the unselected control then becomes the slave actuator 94. If there are more than two trolley actuators, then the additional trolley actuators also become slave actuators if the trolley control associated with the additional actuators is not selected to be the master control by the operator. In the illustrative example, the front trolley control 54a is selected and commanded by the PLC 80 to be the master control 90 and the front trolley actuator 24a is commanded to be the master actuator 92. The rear trolley control 54b is then disabled by the PLC 80 and the rear trolley actuator 24b is commanded by the PLC 80 to be the slave actuator 94. The slave actuator 94 is directed by the master control 90 to move in the same direction and at the same speed as the master actuator 92. Alternatively, the PLC 80 may enable the rear trolley control 54b to be the master control 90. The rear trolley actuator 24b will then be the master actuator 92, and the front trolley actuator 24a will be the slave actuator 94.

At a step 112 (hoist function) or a step 114 (trolley function), the operator moves the master control 90 to direct the master actuator 92 and the slave actuator 94 to move in a certain direction (see FIG. 6B). Synchronized movement of the master and slave actuators is controlled by a motion controller 82. The motion controller 82 may be a proportional (“P”) controller, a proportional-integral (“PI”) controller, a proportional-integral-derivative (“PID”) controller or any other similar device. A single motion controller 82 may be used (see FIG. 1) or multiple motion controllers 82 may be used. The motion controller 82 may be a function block contained within the PLC 80 (see FIGS. 1 and 7A) or it may be stand alone device that is external to the PLC 80 (see FIGS. 1A and FIG. 7B). Because P, PI, and PID controllers are well-known in the art, further detail regarding these devices is not provided herein.

Based on the movement of the master control 90, a signal is sent to the master and slave actuators to move their associated hoists or trolleys. If the motion controller 82, is a function block within the PLC 80, then the motion controller 82 sends the signal to the master actuator 92 and slave actuator 94 via the PLC 80 (see FIG. 7A). If the motion controller 82 is external to the PLC 80, then the motion controller 82 sends the signal directly to the master actuator 92 and slave actuator 94 (see FIG. 7B). The master actuator 92 moves its associated hoists or trolleys in the direction indicated by the master control 90. The slave actuator 94 follows the master actuator 92 and moves its associated hoists or trolleys in the same direction and within a parameterized tolerance value (e.g., speed) as the master actuator 92. For example, if the hoist function has been selected and the front hoist control 54c is the master control 90, then the rear hoist actuator 40b is the slave actuator 94 and will move the rear hoist members 30b in the same direction and at substantially the same speed that the front hoist (master) actuator 40a moves the front hoist members 30a in response to the directional signal sent by the master control 90. This enables the load 34 to be moved in a substantially level manner. Similarly, if the trolley function is selected and the front trolley control 54a is the master control 90, then the rear trolley actuator 24b is the slave actuator 94. The slave actuator 94 moves the rear trolleys 12b, 14b in the same direction and at substantially the same speed at which the front trolley (master) actuator 24a moves the front trolleys 12a, 14a in response to the directional signal provided by the master control 90. The load 34 will therefore be moved in a substantially aligned manner along the front and rear top beams 20 and 22, respectively.

If the hoist function has been selected, then at a step 116, the velocity at which each hoist member 30a, 30b is moving is controlled by the motion controller 82 so that all the hoist members 30a, 30b are raised or lowered at substantially the same rate. The velocity or position of each hoist member 30a, 30b is monitored by the monitoring device 84.

The monitoring device 84 monitors the velocity or position of each hoist member 30a, 30b so that the velocity or position of each hoist member stays within a parameterized tolerance. The monitoring device 84 provides data relating to the speed or position of each hoist member 30a, 30b to the PLC 80. If the motion controller 82 is a function block within the PLC 80, then the motion controller 82 processes the data from the monitoring device to determine if the speed at which the hoists are moving should be increased or decreased. The motion controller then instructs the PLC 80 to send a signal to the master actuator 92 or slave actuator 94 to increase or decrease the speed of the hoists 30a, 30b. If the motion controller 82 is external to the PLC 80, the PLC 80 sends the data from the monitoring device 84 to the motion controller 82. The motion controller 82 then processes the data to determine whether the speed at which the hoists 30a, 30b are being moved should be increased or decreased to keep the speed of all the hoists 30a, 30b within a parameterized tolerance. The motion controller 82 then sends a signal to the master actuator 92 or slave actuator 94 to increase or decrease the speed of the hoists 30a, 30b. If the motion controller 82 is external to the PLC 80, the then PLC 80 signals the motion controller 82 to increase or decrease the speed of the hoists 30a, 30b via the hoist actuators 40a, 40b.

If the velocity or position of any of the hoists 30a, 30b falls outside the parameterized tolerance, the PLC 80 stops movement of the hoist members 30a, 30b directly or through the motion controller 82 and the system faults at a step 118. At step 120, the operator has to reset the fault, at which point the operator can either restart the synchronization process by enabling synchronization at the step 101 or suspend synchronization at a step 130.

If the trolley function has been selected, then at a step 122, the velocity at which each trolley 12a, 12b, 14a, 14b is moving is controlled by the motion controller 82 so that all the trolleys are moved laterally along the top beams 20, 22 at substantially the same rate. While the trolleys 12a, 12b, 14a, 14b are in motion, the velocity or position of each trolley 12a, 12b, 14a, 14b is monitored by the monitoring device 84. The monitoring device 84 provides data to the PLC 80 relating to the speed at which each trolley 12a, 12b, 14a, 14b is traveling along the top beams 20, 22. The motion controller 80 processes the data from the monitoring device 84. If the motion controller 82 is a function block within the PLC 80, the motion controller 82 instructs the PLC 80 to send a signal to the master actuator 92 or the slave actuator 94 to either accelerate or decelerate the movement of the trolleys to maintain the speed of all the trolleys 12a, 12b, 14a, 14b within a parameterized tolerance. If the motion controller 82 is external to the PLC 80, then the motion controller 82 sends a signal to the master actuator 92 or the slave actuator 94 to either accelerate or decelerate the movement of the trolleys to maintain the speed of all the trolleys 12a, 12b, 14a, 14b within a parameterized tolerance. If the velocity or position of any of the trolleys 12a, 12b, 14a, or 14b falls outside the tolerance, the PLC 80 stops movement of the trolleys directly or through the motion controller 82 and the system faults at a step 124. At step 126, the operator has to reset the fault, at which point the operator can either restart the synchronization process by enabling synchronization at the step 101 or suspend synchronization at the step 130.

Assuming that the movement of all the hoist members 30a, 30b or all of the trolleys 12a, 12b and 14a, 14b stay within there respective parameterized tolerances, at a step 128 movement of the hoist members 30a, 30b or trolleys 12a, 12b, 14a, 14b will stop when the position at which the operator seeks to move the load 34 is reached. If the load 34 is at its final location, then the method is complete. Alternatively, the operator may choose to suspend synchronization of the hoist members 30a, 30b and trolleys 12a, 12b, 14a, 14b at the step 130 by actuating the suspend button 62, thereby ending the method. At that point, the operator will regain manual control of the hoist members 30a, 30b and trolleys 12a, 12b, 14a, 14b. The operator may then finish movement of the load 34 by manual operation. Alternatively, the operator may restart the synchronization process of the hoist members 30a, 30b and trolleys 12a, 12b, 14a, 14b at step 101.

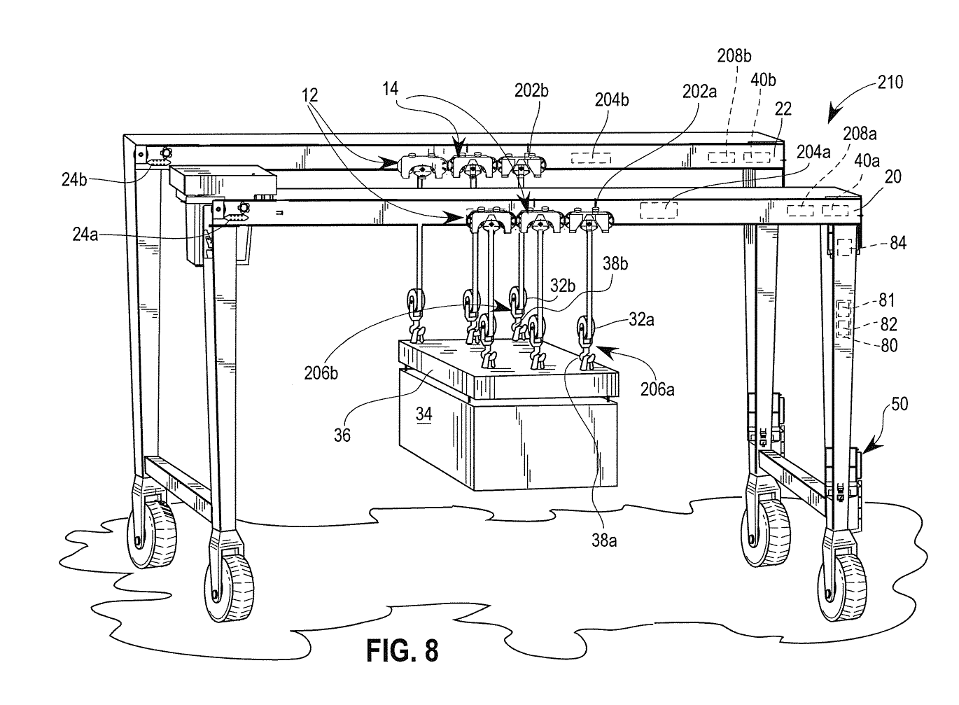

The above method and system can be used with any type of anti-sway technology and may be used in conjunction with multiple trolleys and hoists on the same beams or a single trolley and hoist on multiple beams. FIG. 8 illustrates another embodiment of a crane 210. The crane 210 is the same as the crane 10 with the exception that it includes a third front trolley 202a movably disposed on the front top beam 20 and a third rear trolley 202b movably disposed on the rear beam 22. The third front trolley 202a may be connected to the front trolley actuator 24a or may be connected to a separate front trolley actuator 204a as shown in FIG. 8. Similarly, the third rear trolley 202b may be connected to the rear trolley actuator 24b or may be connected to a separate rear trolley actuator 204b. The front trolley actuator 204a controls the lateral movement of the third trolley 202a along the first top beam 20 of the crane 210. Likewise, the rear trolley actuator 204b controls the lateral movement of the third trolley 202b along the second top beam 22 of the crane 210.

Attached to the movable front trolley member 202a is movable front hoist member 206a, and attached to the movable rear trolley member 202b is movable rear hoist member 206b. The front hoist member 206a may be electronically connected to the front hoist actuator 40a or may be connected to a separate front hoist actuator 208a as shown in FIG. 8. Similarly, the rear hoist member 206b may be electronically connected to the rear hoist actuator 40b or may be attached to a separate rear hoist actuator 208b. The front hoist member 206a may also include hoist sheave block 32a and hook block 38a, and the rear hoist member 206b may include hoist sheave block 32b and hook block 38b.

The front trolley actuator 204a is electronically connected to front trolley control 54a, and the rear trolley actuator 204b is electronically connected to the rear trolley control 54b. The front hoist actuator 208a is electronically connected to the front hoist control 54c, and the rear hoist actuator 208b is electronically connected to the rear hoist control 54d.

When the method 100 and system 200 described above are used in connection with the crane 210, the third trolley 202a, 202b and associated hoist member 206a, 206b operate in the same manner as the front and rear trolleys 12a, 14a and 12b, 14b, respectively, and their associated hoist members 30a, 30b. Thus, the front trolley actuator 204a or the rear trolley actuator 204b may be the master actuator or a slave actuator, depending on whether the operator selects the trolley function or the hoist function and which control the operator uses to select such functions. Likewise, the front hoist actuator 208a or the rear hoist actuator 208b may be the master actuator or a slave actuator, depending on whether the operator selects the trolley function or the hoist function and which control the operator uses to select the trolley or hoist function.

In a further embodiment of the method 100 and system 200 described above, a load spreader and one or more Micro Electronic Measurement System (“MEMS”) devices may be used. For example, a first MEMS device may be attached to or mounted on the spreader, and a second MEMS device may be attached to or mounted on the trolleys 12a, 12b, 14a, 14b. The MEMS device may, include, for example, an Inertial Measurement Unit (“IMU”) device, an accelerometer, a gyroscope, or the like. The first MEMS device may measure, for example, the acceleration of the spreader alone or in combination with a load. The MEMS IMU device may measure, for example, the acceleration of the trolleys along the beams. The measurements obtained by the MEMS devices may then be sent to the PLC 80. Depending on the whether the measurement falls within or outside a parameterized tolerance, the motion controller 82 may increase or decrease the speed at which the trolley actuators 24a, 24b are moving the trolleys 12a, 12b, 14a, 14b or the speed at which the hoist actuators 40a, 40b are moving the hoist members 30a, 30b.

In another embodiment of the method 100 and system 200 described above, the trolley actuators 24a, 24b and the hoist actuators 40a, 40b are hydraulic valves. In this embodiment, a valve controller is connected to each of the trolley and hoist actuators. Each of the valve controllers includes a motion controller 82 such as a PID. The PLC 80 sends the valve controllers a signal to move the trolleys or hoists. Movement of the trolleys or hoists is effectuated by increasing or decreasing the flow of fluid through a valve associated with each actuator. The flow of fluid through the valve is controlled by a valve spool; opening the valve spool increases the flow of fluid through the valve, which increases the speed of the trolleys or hoists and closing the valve spool decreases the flow of fluid through the valve, which decreases the speed of the trolleys or hoists. The valve controller uses the motion controller 82 to monitor the valve spool position and to determine if the trolleys or hoists are staying within a parameterized tolerance. The valve controller adjusts the actual valve spool (i.e., opens or closes the valve spool) to control flow through the actuator valve to stay within the parameterized tolerance. If the speed at which the trolleys or hoists are moving comes out of the parameterized tolerance, then the system faults as discussed above with respect to method 100.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method of transferring a load using a transport device, the transport device having a first hoist and a second hoist and a first trolley and a second trolley, wherein the first hoist is connected to the first trolley and the second hoist is connected to the second trolley, the method comprising the steps of:
enabling synchronization of the first and second hoists and the first and second trolleys, wherein synchronization includes the steps of:
leveling the first and second hoists; and
squaring the first and second trolleys;
choosing one of a hoist function and a trolley function, wherein the first and second hoists are a first mover and a second mover, respectively, if the hoist function is selected, and wherein the first and second trolleys are the first and second movers, respectively, if the trolley function is selected;
commanding one of the first mover and the second mover to be the master and the other mover to be the slave, wherein the master is connected to a first actuator and the slave is connected to a second actuator;
actuating a master control associated with the master; and
outputting a signal to the first and second actuators, whereby the first actuator moves the master and the second actuator moves the slave in a direction indicated by the master control.

2. The method of claim 1, the transport device further including a program logic controller electronically connected to the master control.

3. The method of claim 2, wherein the program logic controller outputs the signal to the first and second actuators.

4. The method of claim 2, the transport device further including a motion controller that is separate from but electronically connected to the program logic controller, wherein the motion controller outputs the signal to the first and second actuators.

5. The method of claim 4, wherein the signal is transmitted to the motion controller via the program logic controller.

6. The method of claim 2, further including the steps of:
monitoring one of the velocity and the position of the master and the slave with a monitoring device;
providing feedback regarding one of the velocity and the position of the master and the slave to the program logic controller; and
determining if one of the velocity and the position of the master and the slave are within a parameterized tolerance.

7. The method of claim 6, wherein the monitoring device is any one of an encoder, tachometer, resolver, laser, Hall effect sensor, ultrasonic device, gyroscope, and accelerometer or any combination thereof.

8. The method of claim 6, whereby the step of enabling is repeated if one of the velocity and position of one of the master and the slave is not within the parameterized tolerance.

9. The method of claim 1, further including the step of attaching the first and second hoists to a load, such that the load can be moved in a substantially vertical direction by the first and second hoists and a substantially lateral direction by the first and second trolleys.

10. The method of claim 1, further including the step of actuating an indicator mechanism when synchronization is complete.

11. The method of claim 1, further including the step of suspending synchronization.

12. A system for synchronization, the system comprising:
a transport device having a first hoist and a second hoist and a first trolley and a second trolley, wherein the first hoist is connected to the first trolley and the second hoist is connected to the second trolley;
a first hoist actuator connected to the first hoist and a second hoist actuator connected to the second hoist;
a first trolley actuator connected to the first trolley and a second trolley actuator connected to the second trolley;
a program logic controller, wherein the program logic controller includes a synchronization module for synchronizing movement of the first and second hoists and the first and second trolleys; and
a master control connected to one of the first hoist and the first trolley,
wherein the first hoist is a master and the first hoist actuator is a master actuator and the second hoist is a slave and the second hoist actuator is a slave actuator, if operational control of the first and second hoists is selected;
wherein the first trolley is the master and the first trolley actuator is the master actuator and the second trolley is the slave and the second trolley actuator is the slave actuator, if operational control of the first and second trolleys is selected;
wherein the master control sends a signal to move the master via the master actuator and move the slave via the slave actuator such that the slave moves at substantially the same rate as the master.

13. The system of claim 12, wherein the program logic controller also includes a monitoring device for monitoring one of the velocity and the position of the master and the slave.

14. The system of claim 13, wherein movement of the master and slave is stopped if one of the velocity and the position of one of the master and the slave is not within a parameterized tolerance.

15. The system of claim 12, further comprising an indicator mechanism that indicates to the user when synchronization of the first and second hoists and the first and second trolleys is complete.

16. The system of claim 15, wherein the indicator mechanism may be any one of a visual, audible, and physical alarm or any combination thereof.

17. The system of claim 12, wherein synchronization includes leveling the first and second hoists and squaring the first and second trolleys.

18. The system of claim 17, further comprising a motion controller electronically connected to the program logic controller for controlling the movement of the master and slave after the first and second hoists have been leveled and the first and second trolleys have been squared.

19. The system of claim 12, wherein the program logic controller receives the signal from the master control and outputs a signal to the master and slave after the first and second hoists have been leveled and the first and second trolleys have been squared.

20. The system of claim 12, wherein the transport device includes a third hoist connected to a third hoist actuator and a third trolley connected to a third trolley actuator, wherein the third hoist is connected to the third trolley.

21. The system of claim 20, wherein the third hoist becomes the slave and the third hoist actuator becomes the slave actuator if operational control of the first, second, and third hoists is selected.

22. The system of claim 20, wherein the third trolley becomes the slave and the third trolley actuator becomes the slave actuator if operational control of the first, second, and third trolleys is selected.

23. The system of claim 12, furthering comprising
a first pre-set location disposed at a first point on a lateral member of the transport device; and
a first control associated with the first pre-set location,
wherein one of the first trolley and the second trolley is moved along the lateral member to the first pre-set location when the first control is actuated.

24. The system of claim 23, further comprising
a second pre-set location disposed at a second point on the lateral member of the transport device, wherein the second point is disposed at a distance from the first point; and
a second control associated with the second pre-set location,
wherein one of the first trolley and the second trolley is moved along the lateral member to the second pre-set when the second control is actuated.

25. The system of claim 12, furthering comprising
a first pre-set position, the first pre-set position being located proximate one of the first trolley and the second trolley; and
a first control associated with the pre-set position,
wherein one of the first hoist and the second hoist is moved to the first pre-set position when the first control is actuated.

26. The system of claim 25, furthering comprising
a second pre-set position, the second pre-set position being distal to one of the first trolley and the second trolley; and
a second control associated with the second pre-set position,
wherein one of the first hoist and the second hoist is moved to the second pre-set position when the second control is actuated.
